(19) United States
(12) Patent Application Publication
(10) Pub. No.: US 2016/0059341 A1
(43) Pub. Date: Mar. 3, 2016

(54) MULTI-CONSUMABLE TORCH TIP AND SYSTEMS AND METHODS OF USING THE SAME

(71) Applicant: LINCOLN GLOBAL, INC., City of Industry, CA (US)

(72) Inventors: Steven R. PETERS, Huntsburg, OH (US); Dionysus DAMATO, Incline Village, NV (US); William Thomas Matthews, Chesterland, OH (US); Michael S. FLAGG, Aurora, OH (US)

(21) Appl. No.: 14/470,459

(22) Filed: Aug. 27, 2014

(51) Int. Cl. B23K 9/12

(52) U.S. Cl. CPC B23K 9/121; B23K 9/125

(57) ABSTRACT

A system and method is provided where a torch having a consumable manifold can direct one of a plurality of possible consumables to a workpiece for an operation without having the need to re-run a consumable or use a different torch. The torch manifold has at least two feeding throats which feed into a common main throat which then couples to the throat of a torch tip to deliver the desired consumable.

### BACKGROUND OF THE INVENTION

1. Field of the Invention

Systems and methods of the present invention relate to welding, joining, brazing and cladding, and more specifically to a multi-consumable torch tip that can be used for welding, joining, brazing and cladding operations.

2. Description of the Related Art

Many workpieces that are to be welded, joined, brazed and/or clad often require the use of multiple consumables, having different physical or chemical characteristics. For example, in some applications a first welding pass will require a first consumable and a second pass of the same weld will require a second consumable. Typically, in such situations at least two different welding torches are utilized—one for each consumable. Alternatively, if only a single torch is available a user will have to change consumables completely. This can result in added expense and delay for the welding operation and is undesirable.

Further limitations and disadvantages of conventional, traditional, and proposed approaches will become apparent to one of skill in the art, through comparison of such approaches with embodiments of the present invention as set forth in the remainder of the present application with reference to the drawings.

### BRIEF SUMMARY OF THE INVENTION

Embodiments of the present invention include equipment and methods which use a consumable delivery torch which has a manifold portion having at least a first and second consumable inlet throat, where the first and second consumable inlet throats are separate from each other. The first inlet throat is configured to receive a first consumable and the second inlet throat is configured to receive a second consumable. The manifold portion has a single exit throat where each of the first and second inlet throats are coupled to the exit throat. The torch includes a contact tip coupled to the manifold portion and having a contact tip throat where an inlet to the contact tip throat aligns with the manifold portion single exit throat. Each of the manifold single exit throat and the contact tip throat are configured such that only one of the first and second consumables can be present in the respective throats at one time.

### BRIEF DESCRIPTION OF THE DRAWINGS

The above and/or other aspects of the invention will be more apparent by describing in detail exemplary embodiments of the invention with reference to the accompanying drawings, in which:

FIG. 1 is a diagrammatical representation of an exemplary system using an exemplary embodiment of the present invention;

FIG. 2 is a diagrammatical representation of an exemplary embodiment of a multi-wire torch of the present invention shown during use;

FIG. 3 is a diagrammatical representation of a cross-section of an exemplary embodiment of a multi-wire torch of the present invention;

FIGS. 4A and 4B are diagrammatical representations of further exemplary embodiments of a multi-wire torch of the present invention;

FIG. 5 is a diagrammatical representation of an additional exemplary embodiment of a multi-wire torch of the present invention;

FIG. 6 is a diagrammatical representation of a flow chart for an operation of a system employing an embodiment of the present invention.

### DETAILED DESCRIPTION OF EXEMPLARY EMBODIMENTS

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

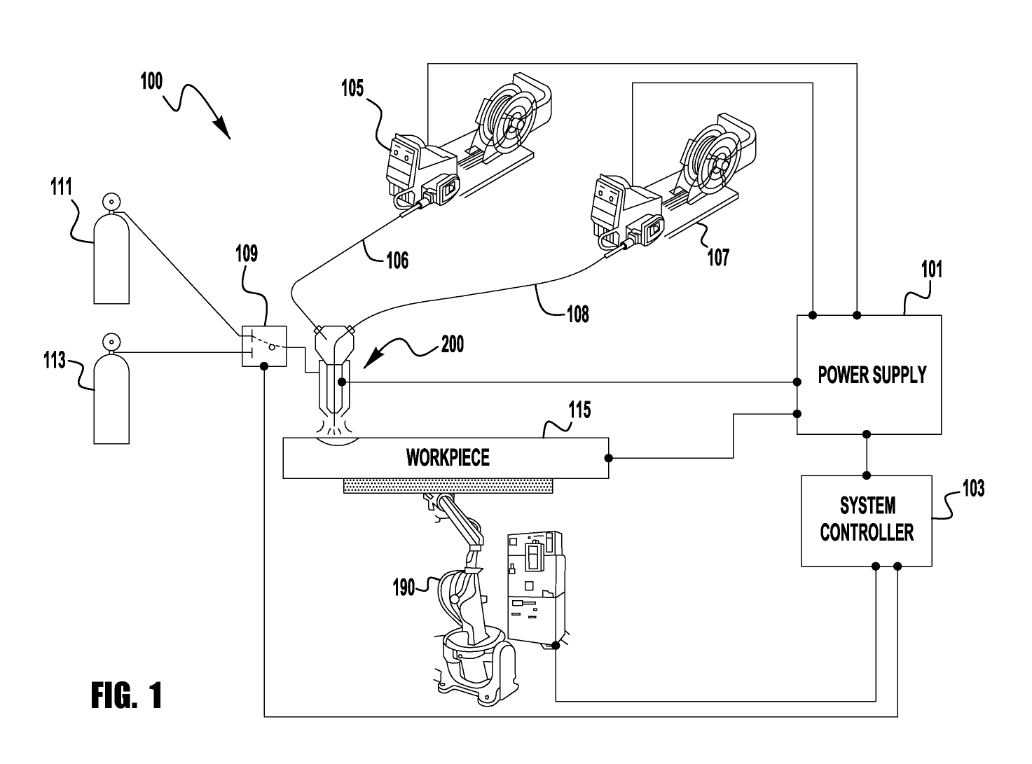

FIG. 1 depicts an exemplary system 100 using an embodiment of the present invention. It is noted that for purposes of the following discussion, the system will be discussed as an arc welding system using an arc welding power supply 101. However, exemplary embodiments are not limited to being used in arc welding system. Embodiments of the present invention can be used with many systems which require the deposition of a wire consumable onto a surface or a workpiece. For example, embodiments of the present invention can be used with arc welding, electroslag welding, cladding, joining, hot wire and additive manufacturing systems without departing from the spirit or scope of the present invention. Arc welding systems can be of the GMAW, GTAW, SAW, FCAW type, as an example. Further, exemplary embodiments of the present invention can be used in automatic, robotic, semi-automatic and manual systems. As indicated above, the exemplary embodiments discussed herein will use an arc welding system as exemplary but this is in no way intended to be limiting.

The system 100 uses a power supply 101 having a known construction and operation. In the system shown in FIG. 1 the power supply 101 is an arc welding power supply of a known type. Because the construction and operation of such power supplies are known, the details of which need not be discussed herein. Coupled to the power supply 101 is a system controller 103 which provides a controller function for the system 100 and its components. Although the controller 103 is shown exterior to the power supply 101, it is noted that in exemplary embodiments of the present system the controller 103 can be internal to the power supply 103. The controller 103 can be any type of computer or microcontroller which is capable of controlling the system 100 and the components thereof. Such controllers 103 are generally known and need not be discussed in detail herein.

The system 100 is also shown to have two wire feeders 105 and 107 as embodiments of the present invention allow the use of multiple consumables easily. It is noted that in exemplary embodiments additional wire feeders or wire feeding sources can be used. Further, a single dual-feeder wire feeder can also be utilized. It is not necessary that the system 100 use separate wire feeding devices. Dual-feeding wire feeders are general known and need not be described in detail herein. In the system 100 shown the wire feeders 105 and 107 are coupled to the power supply 101 which controls the operation of the wire feeders 105 and 107. However, in other embodiments, the wire feeders 105 and 107 can be controlled by the controller 103 and communicatively coupled thereto. Each of the wire feeders 105/107 provide the consumables 106 and 108 to the operation, respectively. The consumables can be any type of wire consumable, such as a welding electrode, brazing wire, cladding wire, etc. The consumables 106 and 108 can have different physical properties (e.g., diameters) and/or have different chemistries as needed for a desired operation. For example, some welding applications may need to use both a mild steel and a stainless steel consumable. Further, some embodiments can have different diameters for the respective throats 213, 214, to accommodate consumables of different diameters. Of course the throats 215 and 205 should have a diameter appropriate for the largest diameter of consumable to be accommodated. Embodiments of the present invention allow the easy use of multiple consumables for a given operation.

Also shown in FIG. 1, the system 100 has a motion control device 190, which ca be a robot, or the like. The motion control device 190 can move the workpiece 115 and/or the torch 200 to facilitate the desired operation. Motion control devices 190 such as robots, and the like, are generally known and need not be described in detail herein.

The exemplary system 100 also is shown to have two gas sources 111 and 113, which provide different gases or gas compositions to the operation. For example, if the system 100 is a GMAW type welding system then shielding gas is used. Because the consumables 106 and 108 can be different consumables having different compositions then it may be necessary to use two different shielding gases. For example a first shielding gas may be needed for welding with a first consumable 106, while a second shielding gas may be needed for welding with a second consumable 108. Thus, the gas sources 111 and 113 are coupled to a gas flow manifold 109 which directs the gas to the torch 200 so that it can be delivered to the operation. As shown, the manifold 109 can be a solenoid activated manifold which is controlled by the controller 103 so that the controller 103 can control the flow of the gas so that the appropriate gas is being directed to the operation at the appropriate time.

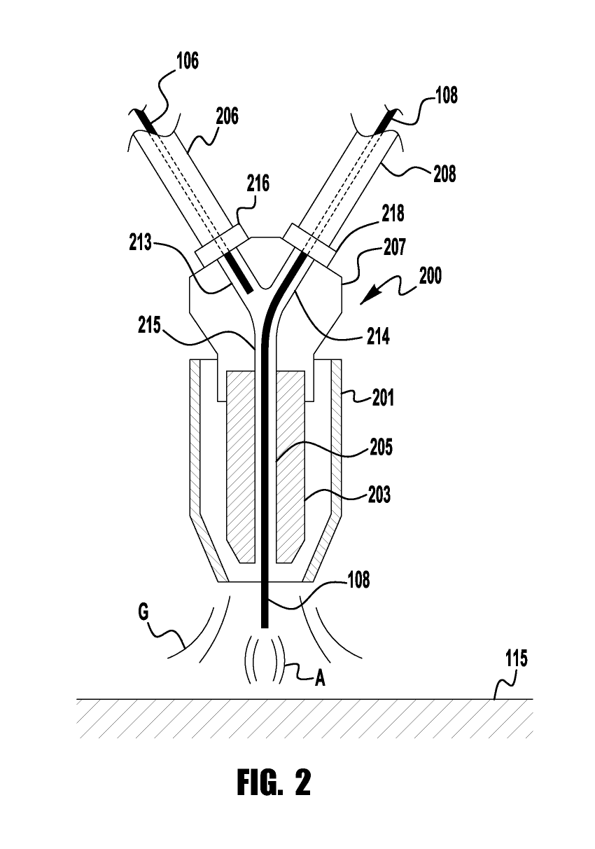

The torch 200 directs the consumables 106/108 and the gas to the operation as needed. Aspects of an exemplary embodiment of the torch 200 will be discussed below with reference to FIGS. 2 through 4.

Turning now to FIG. 2, a diagrammatical cross-section of the torch is shown during a welding operation where an arc A is generated between the consumable 108 and the workpiece 115. In general, embodiments of the torch 200 are constructed and operate similar to known torches which are used to deliver a consumable and/or a shielding gas to a workpiece. Except for the details discussed below much of the operation and construction is similar to known torches. The torch 200 has a nozzle 201 which directs a gas, such as a shielding gas G to the work area. The nozzle 201 can be constructed similar to known nozzle constructions to provide for the appropriate gas delivery. Positioning within the nozzle is a torch tip 203. The torch tip 203 is electrically coupled to the power supply 101 and it is through the torch tip that electrical current can be provided to the consumable 106/108 as it passes through a throat 205 of the torch tip 203. In some applications, it may not be necessary to provide current to the tip 203 as the tip 203 is used to simply deliver the consumable 106/108 to the operation. Such operations can include GTAW. In any event, the tip 203 can be constructed similar to known tip constructions. For example, the tip can be made from copper and have a single throat 205 through which the consumable 106/108 passes to be delivered to the workpiece. Coupled to the upstream end of the tip 203 is a multi-wire tip manifold 207.

The manifold 207 has a common throat portion 215 through which the consumables 106/108 pass to enter the tip 203. That is, the throat 215 of the manifold 207 matches up with the throat 205 of the tip 203 so that a consumable can easily pass from the manifold 215 to the tip 203. The manifold 207 also has at least two feeder throats 213 and 214 which connect with each other and the throat 215. On an outer surface of the manifold 207 are at least two connectors 216 and 218 to which wire delivery cables 206 and 208 are connected. Through the cables 206/208 the consumables 106 and 108 are delivered to the manifold 207. However, as shown, at any one time only one of the consumables 106/108 is passing through the common throat 215 and into the tip 203. It should be noted that although a only two consumables 106/108 are shown in the disclosed embodiments, other embodiments of the present invention allow for more than two consumables. That is, three or more consumables can be directed to the manifold 207, each having their own feeder throat which couples to the common throat 215. Further discussion of the tip and manifold is set forth below.

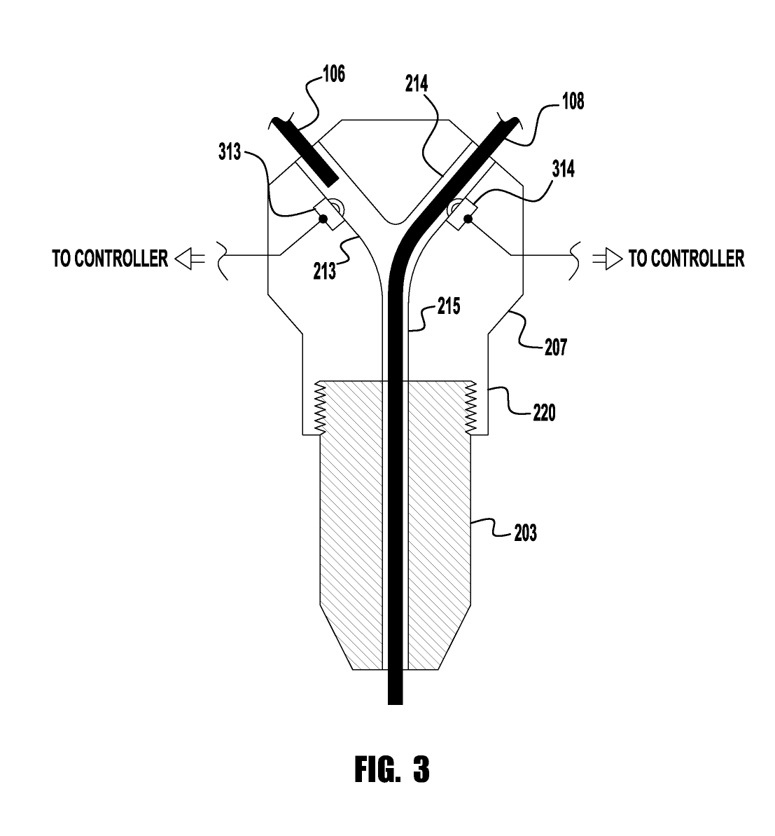

FIG. 3 depicts a cross-section of an exemplary embodiment of the present invention. As shown the manifold 207 has a connection portion 220 on the distal end of the manifold 207 so that it can be coupled to the tip 203. In the embodiment shown the connection can be a thread type connection. However, other connections methodology can be employed, such as press fit, etc. Further, in other exemplary embodiments, the tip and manifold can be an integrally made structure, and need not be formed in distinct components as depicted. Further, although the manifold is generally depicted as an integrally made components, in other embodiments the manifold 207 can be made from a plurality of components, such as two-halves. That is, it may be easier to manufacture the manifold 207 as separate components which are then secured to each other with bolts or fasteners or the like. Such a configuration does not depart from the spirit or scope of the present invention.

As shown in FIG. 3, in some exemplary embodiments the manifold includes sensors 313 and 314 which are used to detect the presence of the consumables 106 and 108 in the respective feeder throats 213 and 214. The sensors are electrically coupled to the controller of the system 100 so that the controller 103 is can determine whether or not a consumable is present within the respective throats. This ensures that the controller 103 maintains only a single consumable through the tip at any one time. This operation will be discussed in more detail below. The sensors 313/314 can be any type of sensor which is capable of detecting the presence of a consumable in the feeder throats 213/214. The sensors in FIG. 3 are contact type sensors which make contact with the respective consumables 106/108 to determine if they are present in the respective throats, such as pressure switches. However, to the extent contact switches are used they are to be of a type that do not substantially interfere with the movement of the consumables through the manifold. In other exemplary embodiments, the sensors can be other type of sensors, such as optical, magnetic, etc. In any event, the sensors 313/314 should be of a type that can detect the presence of a consumable and/or detect when the consumable has been retracted to a position upstream of the switch 313/314.

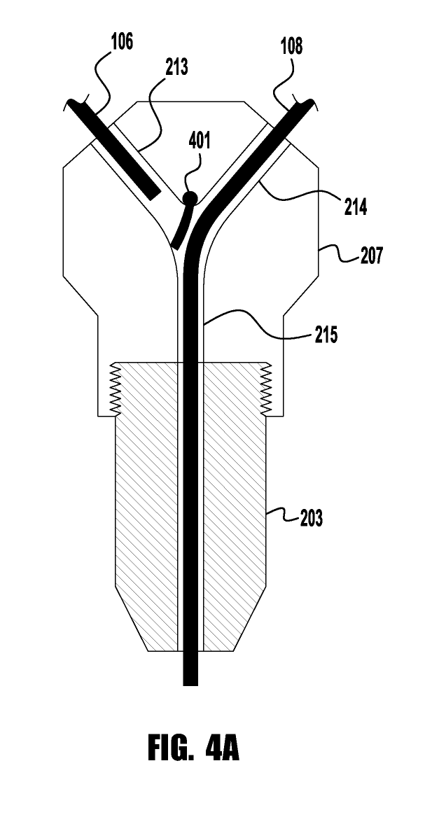

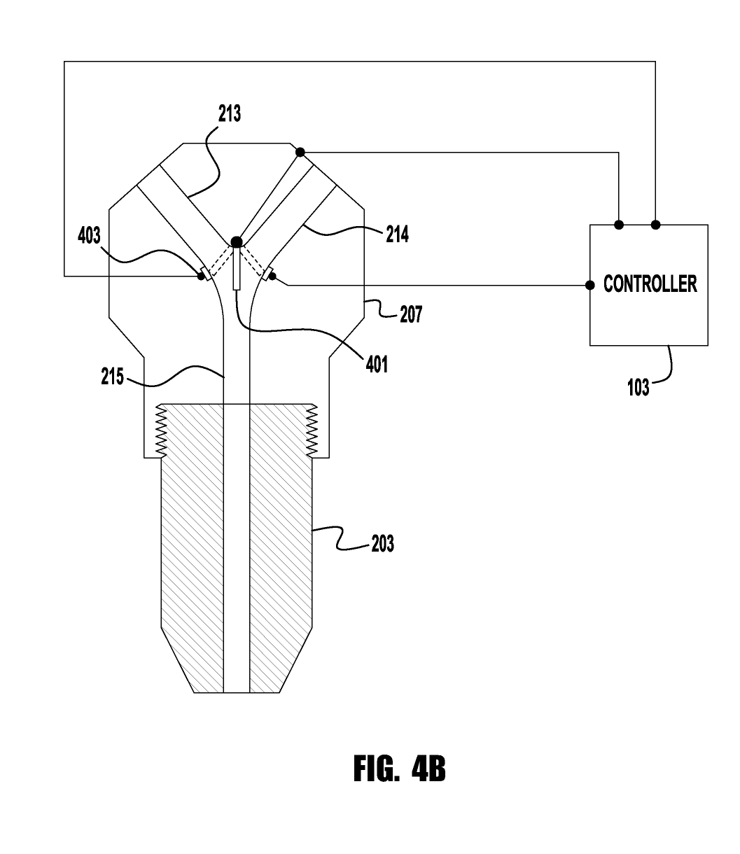

FIG. 4A depicts another exemplary embodiment of the present invention, where the manifold 207 includes a valve structure 401 which is pivotably coupled to the manifold 207 at a location near where the feeder throats 213/214 converge to form the main throat 215. This valve structure 401 can have any desired shape or configuration, and can be mounted to the manifold in any way which allows the valve structure 401 to pivot within the throats. The valve structure 401 has a design such that it blocks the other of the feeder throats when a consumable from a different feeder throat is present and in the main throat 215. For example, as shown in FIG. 4A, the consumable 108 is inserted into the main throat 215 and tip 207. Because of the this, the valve structure 401 is biased to close the feeder throat off from the main throat 215. Thus, the consumable 106 is physically blocked from the main throat 215 such that if the consumable 106 is inadvertently advanced it would be physically blocked from the main throat until such time as the consumable 108 is sufficiently withdrawn. While the valve structure 401 should be sturdy enough to physically block the main throat to prevent inadvertent insertion of a consumable, it should also be a shape and construction which does not interfere with the proper advancement of a consumable or otherwise scar or scratch the surface of a consumable. For example, the valve structure 401 can be made from a hard plastic material. Additionally, while in some embodiments the movement of the valve structure 401 can be facilitated by the consumables (i.e., passive control), in other exemplary embodiments the valve 401 can be controlled by a solenoid or actuator, or similar type of motion control mechanism. In a passive system, the simple motion of a consumable from the feeder throat to the main throat will cause the valve 401 to move and block the other feeder channel, whereas in embodiments in which an actuator is used, the controller 103 can control the operation of the valve 401 and use information from the sensors 313/314 to aid in control of the valve.

In further exemplary embodiments, as generally depicted in FIG. 4B, the valve 401 can act as a contact for a switch which engages with one of two electrical contacts 403 on the respective inner surface of the feeder throats 213/214 such that based on which circuit path is closed the controller 103 can determine the status of each of the respective consumables. For example, If the consumable 108 is fully inserted into the torch 200 as shown in FIG. 4, a distal tip of the valve 401 makes contact with a contact portion 403 on an inner surface of the feeder throat 213 which indicates to the controller 103 that the consumable 108 is fed through the torch 200 and the consumable 106 is sufficiently retracted. Similar control methodology would apply if the consumable 106 were inserted into the main throat 215 and the consumable 108 was retracted. In additional embodiments, the valve 401 can have a neutral position where it makes no signal contact with any sidewall such that the control circuit would be open. This indicates to the controller that the valve 401 is not engaged with any sidewall and thus that no consumable is into the main throat 215, which allows the controller 103 to advance the desired electrode without the need to retract the other electrode. It should be noted that embodiments of the present invention are not limited to having the contacts 403 within the cavity of the feeding throats 213/214, but they can also be positioned on respective sidewalls of the main throat 215 without departing from the spirit or scope of the present invention.

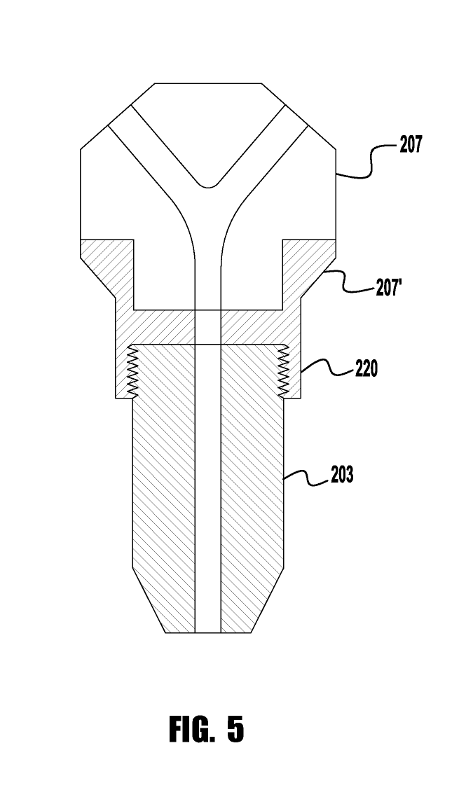

FIG. 5 depicts another exemplary embodiment of the present invention, where a dielectric spacer 207′ is positioned between the manifold 207 and the tip 203. The spacer 207′ is used to electrically isolate the tip 203 and the manifold 207 for torch configurations where isolation is desired. Further, in other exemplary embodiments, the manifold 207 can itself be made from a dielectric material. In the FIG. 5 embodiment the manifold 207 is press fit into the dielectric spacer 207′ which is then secured to the tip 203 via the distal thread portion 220.

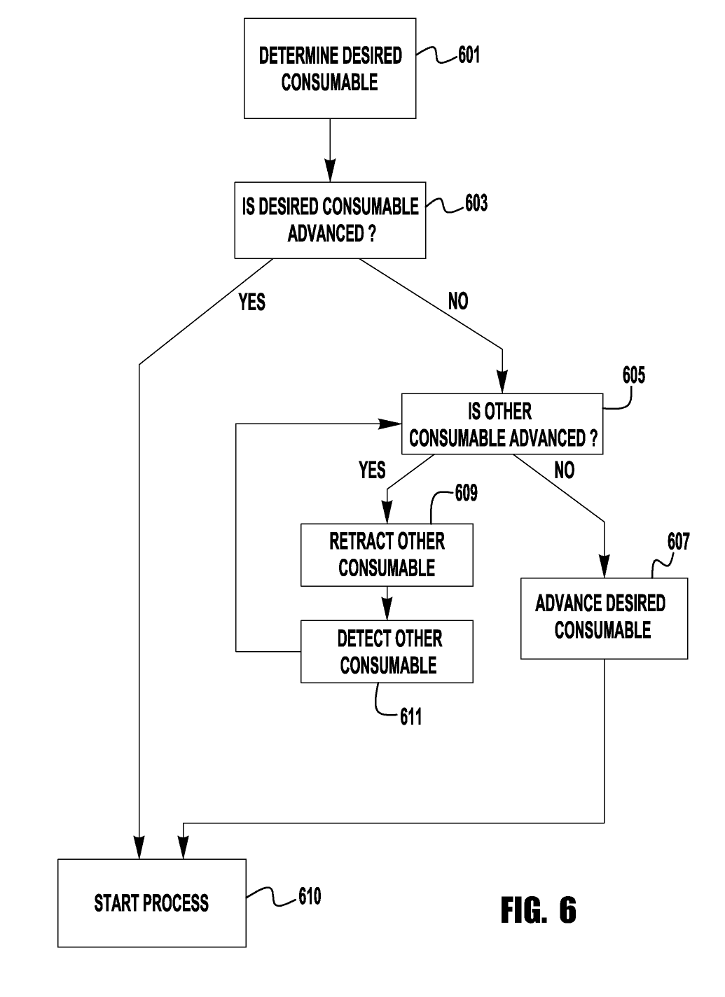

FIG. 6 depicts a flow chart for an operation of a system 100 in accordance with an exemplary embodiment of the present invention. This operation can be executed by the controller 103 or any other control system or device used to control the operation of the wire feeders 105/107 and/or the system 100. Further, the flow chart in FIG. 6 is one example of an exemplary system 100 may be operated, as other methods of control can be used without departing from the scope or spirit of the invention.

When a desired operation is to be started, either a user or a controller or control system will determine the desired consumable (step 601) for the chosen operation. For example, either the user or a robotic control system will determine that a first consumable (e.g., mild steel) is to be used. The controller 103 will then determine (step 603) if that desired consumable is advanced through the torch 200. This can be done in a number of ways, including the use of sensors as described above. This can also be determined by the controller 103 by using the data from a previous operation. That is, if the desired consumable was the last consumable used from a previous operation then the controller 103 can determine that the desired consumable has remained within the torch 200 as needed. Of course, although not shown, the controller 103 can use any known control methodology to ensure that the desired consumable is extended beyond the tip 203 by the desired distance for a given operation. As shown, if the desired consumable is advanced through the torch 200 then the process can be started as desired at step 610. However, if the desired consumable is not advanced then a determination as to whether or not another consumable is advanced or present in the torch 200 (step 605). If no other consumable is detected as being present within the torch 200 (for example, via the sensors discussed above) then the controller 103 will cause the desired consumable to advance to a desired stickout and then the process can begin (step 610).

However, if another consumable is advanced, or otherwise detected as being in the torch 200 (or main throat 215) then the controller 103 will cause that consumable to be retracted (step 609). The controller 103 will then cause the appropriate wire feeder to retract the other consumable and continue to detect its presence (step 611) until it is determine that the other consumable has been sufficiently withdrawn (e.g., no longer sensed by a sensor). After the other consumable has been retracted the appropriate consumable will then be advanced (607) and the process can begin (610).

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

What is claimed is:

1. A consumable delivery torch, comprising:
a manifold portion having at least a first and second consumable inlet throat, where said first and second consumable inlet throats are separate from each other and said first inlet throat is configured to receive a first consumable and said second inlet throat is configured to receive a second consumable, and wherein said manifold portion has a single exit throat where each of said first and second inlet throats are coupled to said exit throat, and
a contact tip coupled to said manifold portion and having a contact tip throat where an inlet to said contact tip throat aligns with said manifold portion single exit throat,
wherein each of said manifold single exit throat and said contact tip throat are configured such that only one of said first and second consumable can be present in said respective throats at one time.

2. The consumable delivery torch of claim 1, wherein said first inlet throat has a different diameter than said second inlet throat.

3. The consumable delivery torch of claim 1, wherein at least one of said first and second inlet throats comprises a sensor to detect a presence of said first and second consumable, respectively, within said first and second inlet throat.

4. The consumable delivery torch of claim 4, wherein said sensor makes contact with said first or second consumable to detect its presence.

5. The consumable delivery torch of claim 1, wherein said manifold portion further comprises a valve structure which prevents the advancement of one of the first and second consumables when the other of said first and second consumables is present in the single exit throat of said manifold portion.

6. The consumable delivery torch of claim 5, wherein said valve structure is controlled by each of said first and second consumable such that when said first consumable is present in said single exit throat said valve structure prevents said second consumable from advancing into said single exit throat, and when said second consumable is present in said single exit throat said valve structure prevents said first consumable from advancing into said single exit throat.

7. The consumable delivery torch of claim 5, wherein said valve structure is controlled by a controller so that only one of said first and second consumable can be advanced into said single exit throat at a given time.

8. The consumable delivery torch of claim 1, wherein said manifold portion is coupled to said contact tip via a dielectric spacer.

9. A manifold for a consumable delivery torch, comprising:
a manifold body portion having at least a first and second consumable inlet throat, where said first and second consumable inlet throats are separate from each other and said first inlet throat is configured to receive a first consumable and said second inlet throat is configured to receive a second consumable, and wherein said manifold portion has a single exit throat where each of said first and second inlet throats are coupled to said exit throat,
wherein said single exit throat is configured such that only one of said first and second consumable can be present in said single exit throat at one time.

10. The manifold of claim 9, wherein said first inlet throat has a different diameter than said second inlet throat.

11. The manifold of claim 9, wherein at least one of said first and second inlet throats comprises a sensor to detect a presence of said first and second consumable, respectively, within said first and second inlet throat.

12. The manifold of claim 11, wherein said sensor makes contact with said first or second consumable to detect its presence.

13. The manifold of claim 9, wherein said manifold body portion further comprises a valve structure which prevents the advancement of one of the first and second consumables when the other of said first and second consumables is present in the single exit throat of said manifold portion.

14. The consumable delivery torch of claim 13, wherein said valve structure is controlled by each of said first and second consumable such that when said first consumable is present in said single exit throat said valve structure prevents said second consumable from advancing into said single exit throat, and when said second consumable is present in said single exit throat said valve structure prevents said first consumable from advancing into said single exit throat.

15. The consumable delivery torch of claim 13, wherein said valve structure is controlled by a controller so that only one of said first and second consumable can be advanced into said single exit throat at a given time.

16. A consumable delivery system, comprising:
a consumable delivery torch, said torch comprising:
a manifold portion having at least a first and second consumable inlet throat, where said first and second consumable inlet throats are separate from each other and said first inlet throat is configured to receive a first consumable and said second inlet throat is configured to receive a second consumable, and wherein said manifold portion has a single exit throat where each of said first and second inlet throats are coupled to said exit throat, and
a contact tip coupled to said manifold portion and having a contact tip throat where an inlet to said contact tip throat aligns with said manifold portion single exit throat,
wherein each of said manifold single exit throat and said contact tip throat are configured such that only one of said first and second consumable can be present in said respective throats at one time,
a first wire feeding system which directs said first consumable to said manifold portion,
a second wire feeding system which directs said second consumable to said manifold portion, and
a controller which controls each of said first and second wire feeding systems such that only one of said first and second consumables is present in said single exit throat at any given time.

17. The system of claim 16, wherein at least one of said first and second inlet throats comprises a sensor to detect a presence of said first and second consumable, respectively, within said first and second inlet throat.

18. The system of claim 1, wherein said manifold portion further comprises a valve structure which prevents the advancement of one of the first and second consumables when the other of said first and second consumables is present in the single exit throat of said manifold portion.

19. The consumable delivery torch of claim 18, wherein said valve structure is controlled by said controller so that only one of said first and second consumable can be advanced into said single exit throat at a given time.
